(19) United States
(12) Patent Application Publication
(10) Pub. No.: US 2026/0044438 A1
(43) Pub. Date: Feb. 12, 2026

(54) STREAMLINING INTEGRATION TESTING USING LARGE LANGUAGE MODELS

(71) Applicant: SAP SE, Walldorf (DE)

(72) Inventor: Nagendra Reddy Devireddy, Bangalore (IN)

(21) Appl. No.: 18/795,707

(22) Filed: Aug. 6, 2024

(51) Int. Cl. G06F 11/36

(52) U.S. Cl. CPC G06F 11/3688

(57) ABSTRACT

In an example embodiment, Large Language Models (LLMs) are leveraged to augment training data used to train a machine learning model to imitate responses to requests in a microservices system. A recorder is used to record requests from and responses to a microservice. This recorded information can then be used as context for an LLM prompt sent to an LLM. Based on this prompt, the LLM then generates dependencies, configurations, and integrations that can be used along with the recorded information itself as a training data set. The training data set is then used to train a mock server that is able to imitate an integration testing scenario, including replicating a setup procedure for the components and replicating responses and requests generated by those components, permitting integration testing without copies of actual components to be configured and run.

### TECHNICAL FIELD

This document generally relates to computer systems. More specifically, this document relates to use of large language models (LLMs) for integration testing.

### BACKGROUND

Software programs typically undergo a battery of testing during their lifetimes. For example, software may evolve as problems are discovered and then fixed by patches, and also as new features are added. Integration testing refers to the testing of integrated parts of the software, for example the interaction between new/changed features and existing features.

A Large Language Model (LLM) refers to an artificial intelligence (AI) system that has been trained on an extensive dataset to understand and generate human language. These models are designed to process and comprehend natural language in a way that allows them to answer questions, engage in conversations, generate text, and perform various language-related tasks.

### BRIEF DESCRIPTION OF DRAWINGS

The present disclosure is illustrated by way of example and not limitation in the figures of the accompanying drawings, in which like references indicate similar elements.

FIG. 1 is a block diagram illustrating a system for integration testing a microservice, in accordance with an example embodiment.

FIG. 2 is a block diagram illustrating the system of FIG. 1, where the LLM is directly used in integration testing rather than merely used to generate training data to train a model used in integration testing.

FIG. 3 is a sequence diagram illustrating a method for training a mock server machine learning model to imitate components in a microservices environment for integration testing, in accordance with an example embodiment.

FIG. 4 is a sequence diagram illustrating a method for integration testing a first microservice in a microservices environment, in accordance with an example embodiment.

FIG. 5 is a flow diagram illustrating a method in accordance with an example embodiment.

FIG. 6 is a block diagram illustrating an architecture of software, which can be installed on any one or more of the devices described above.

FIG. 7 illustrates a diagrammatic representation of a machine in the form of a computer system within which a set of instructions may be executed for causing the machine to perform any one or more of the methodologies discussed herein, according to an example embodiment.

### DETAILED DESCRIPTION

The description that follows discusses illustrative systems, methods, techniques, instruction sequences, and computing machine program products. In the following description, for purposes of explanation, numerous specific details are set forth in order to provide an understanding of various example embodiments of the present subject matter. It will be evident, however, to those skilled in the art, that various example embodiments of the present subject matter may be practiced without these specific details.

Cloud computing can be described as Internet-based computing that provides shared computer processing resources and data to computers and other devices on demand. Users can establish respective sessions during which processing resources and bandwidth are consumed. During a session, for example, a user is provided on-demand access to a shared pool of configurable computing resources (e.g., computer networks, servers, storage, applications, and services). The computing resources can be provisioned and released (e.g., scaled) to meet user demand.

A common architecture in cloud platforms includes services (also referred to as microservices), which have gained popularity in service-oriented architectures (SOAs). In such SOAs, applications are composed of multiple, independent services. The services are deployed and managed within the cloud platform and run on top of a cloud infrastructure. In some examples, service-based applications can be created and/or extended using an application programming framework. In an example embodiment, the software servers created implement the services.

It is common for microservices to be updated occasionally to fix bugs and/or roll out new features or functionality. Typically such updates are implemented in the form of code changes. Each code change can be implemented one at a time at a microservice. Prior to allowing a recently-changed microservice to be used in regular service, it is common to require some level of testing of the recently-changed microservice, and to specifically test how the newly-changed aspects of the microservice affect or are affected by other microservices, servers, databases, etc., in a system. This is known as integration testing.

An issue that arises, however, in integration testing microservices is that fully testing a microservice is performed by running a full copy of each component in the system that the microservice could affect or could be affected by. This means, for example, that testing Microservice A may necessitate tuning a copy of Microservices B and C, Server D, and Database E. Launching and maintaining such other components for testing purposes can be unwieldy, lead to significant time delays, and add additional cost.

In an example embodiment, Large Language Models (LLMs) are leveraged to augment training data used to train a machine learning model to imitate responses to requests in a microservices system. A recorder is used to record requests from and responses to a microservice (such as communications to and from other microservices, servers, databases, etc., in the system). This recorded information can then be used as context for an LLM prompt sent to an LLM. Based on this prompt, the LLM then generates dependencies, configurations, and integrations that can be used along with the recorded information itself as a training data set. The training data set is then used to train a mock server that is able to imitate an integration testing scenario, including replicating a setup procedure for the components and replicating responses and requests generated by those components, permitting integration testing without copies of actual components to be configured and run.

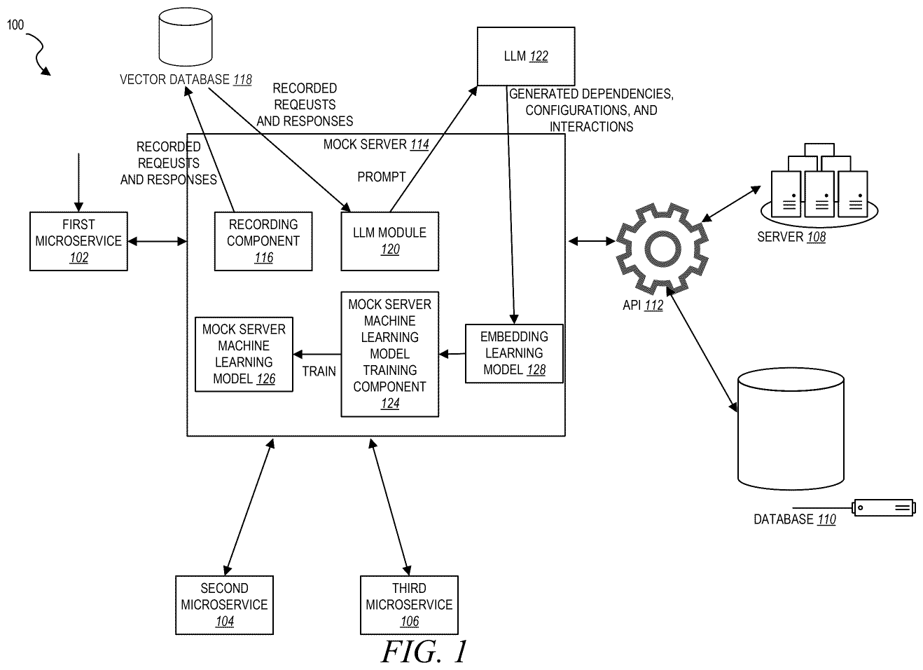

FIG. 1 is a block diagram illustrating a system 100 for integration testing a microservice, in accordance with an example embodiment. Here, the system includes a first microservice 102, a second microservice 104, and a third microservice 106. The first microservice 102 communicates with the second microservice 104 and the third microservice 106 through a series of requests and responses. The first microservice 102 also communicates with a server 108 and a database 110 via an Application Program Interface (API) 112. In this example, a user may wish to perform integration testing of the first microservice 102, such as if the first microservice 102 received a recent update via a code change by the user.

In an example embodiment, a mock server 114 is provided between the first microservice 102 and the other components in the system (second microservice 104, third microservice 106, server 108, database 110, and API 112). A recording component 116 on the mock server 114 acts to record all requests and responses to and from the first microservice 102, including, for example, requests to configure the other components in the system 100.

The recorded information is stored in a vector database 118, here depicted as separate from the mock server 114 although in some example embodiments the vector database 118 may be contained within the mock server 114 itself. The vector database 118 may serve two purposes. The first is to provide a place where recorded requests and responses can be easily accessed for inclusion as contextual information for an LLM prompt. The second is to provide a place where actual past requests and responses can be retrieved for direct use in cases where a new request exactly matches a past request. For the first case, an LLM module 120 generates a prompt to an LLM 122. This prompt may include the recorded requests and responses to and from the first microservice 102 as contextual information. The prompt may request that the LLM 122 generate dependencies between components, configurations of components, and/or interactions between components. Since this is all generated by the LLM 122, essentially these dependencies, configurations, and interactions are “fake,” in that they were not generated by or for a component itself but instead generated as an attempt at imitating that component.

LLMs used to generate information are generally referred to as Generative Artificial Intelligence (GAI) models. A GAI model may be implemented as a generative pre-trained transformer (GPT) model or a bidirectional encoder. A GPT model is a type of machine learning model that uses a transformer architecture, which is a type of deep neural network that excels at processing sequential data, such as natural language.

A bidirectional encoder is a type of neural network architecture in which the input sequence is processed in two directions: forward and backward. The forward direction starts at the beginning of the sequence and processes the input one token at a time, while the backward direction starts at the end of the sequence and processes the input in reverse order.

By processing the input sequence in both directions, bidirectional encoders can capture more contextual information and dependencies between words, leading to better performance.

The bidirectional encoder may be implemented as a Bidirectional Long Short-Term Memory (BILSTM) or BERT (Bidirectional Encoder Representations from Transformers) model.

Each direction has its own hidden state, and the final output is a combination of the two hidden states.

Long Short-Term Memories (LSTMs) are a type of recurrent neural network (RNN) designed to overcome the vanishing gradient problem in traditional RNNs, which can make it difficult to learn long-term dependencies in sequential data.

LSTMs include a cell state, which serves as a memory that stores information over time. The cell state is controlled by three gates: the input gate, the forget gate, and the output gate. The input gate determines how much new information is added to the cell state, while the forget gate decides how much old information is discarded. The output gate determines how much of the cell state is used to compute the output. Each gate is controlled by a sigmoid activation function, which outputs a value between 0 and 1 that determines the amount of information that passes through the gate.

In BILSTM, there is a separate LSTM for the forward direction and the backward direction. At each time step, the forward and backward LSTM cells receive the current input token and the hidden state from the previous time step. The forward LSTM processes the input tokens from left to right, while the backward LSTM processes them from right to left.

The output of each LSTM cell at each time step is a combination of the input token and the previous hidden state, which allows the model to capture both short-term and long-term dependencies between the input tokens.

BERT applies bidirectional training of a model known as a transformer to language modeling. This is in contrast to prior art solutions that looked at a text sequence either from left to right or combined left to right and right to left. A bidirectionally trained language model has a deeper sense of language context and flow than single-direction language models.

More specifically, the transformer encoder reads the entire sequence of information at once and thus is considered to be bidirectional (although one could argue that it is, in reality, non-directional). This characteristic allows the model to learn the context of a piece of information based on all of its surroundings.

In other example embodiments, a generative adversarial network (GAN) embodiment may be used. A GAN is a supervised machine learning model that has two sub-models: a generator model that is trained to generate new examples and a discriminator model that tries to classify examples as either real or generated. The two models are trained together in an adversarial manner (using a zero-sum game according to game theory) until the discriminator model is fooled roughly half the time, which means that the generator model is generating plausible examples.

The generator model takes a fixed-length random vector as input and generates a sample in the domain in question. The vector is drawn randomly from a Gaussian distribution, and the vector is used to seed the generative process. After training, points in this multidimensional vector space will correspond to points in the problem domain, forming a compressed representation of the data distribution. This vector space is referred to as a latent space or a vector space comprised of latent variables. Latent variables, or hidden variables, are those variables that are important for a domain but are not directly observable.

The discriminator model takes an example from the domain as input (real or generated) and predicts a binary class label of real or fake (generated).

Generative modeling is an unsupervised learning problem, although a clever property of the GAN architecture is that the training of the generative model is framed as a supervised learning problem.

The two models, the generator and discriminator, are trained together. The generator generates a batch of samples, and these, along with real examples from the domain, are provided to the discriminator and classified as real or fake.

The discriminator is then updated to get better at discriminating real and fake samples in the next round and, importantly, the generator is updated based on how well the generated samples fooled the discriminator.

In another example embodiment, the GAI model is a Variational AutoEncoders (VAEs) model. VAEs comprise an encoder network that compresses the input data into a lower-dimensional representation, called a latent code, and a decoder network that generates new data from the latent code. In either case, the GAI model contains a generative classifier, which can be implemented as, for example, a naïve Bayes classifier.

The present solution works with any type of GAI model, although an implementation that specifically is used with an LLM will be described.

Referring back to FIG. 1, the generated dependencies, configurations, and interactions are sent back to the LLM module 120, which then passes it to a mock server machine learning model training component 124. The mock server machine learning model training component 124 uses a machine learning algorithm to train a mock server machine learning model 126 to imitate the components in the system 100 for use during integration testing. This training may use the generated dependencies, configurations, and interactions from the LLM module 120 along with the recorded data in the vector database 118 as part of the training.

Specifically, the mock server machine learning model 126 may be trained by any algorithm from among many different potential supervised or unsupervised machine learning algorithms. Examples of supervised learning algorithms include artificial neural networks, Bayesian networks, instance-based learning, support vector machines, linear classifiers, quadratic classifiers, k-nearest neighbors, decision trees, and hidden Markov models.

In an example embodiment, a machine learning algorithm used to train the mock server machine learning model 126 may iterate among various weights (which are the parameters) that will be multiplied by various input variables and evaluate a loss function at each iteration, until the loss function is minimized, at which stage the weights/parameters for that stage are learned. Specifically, the weights are multiplied by the input variables as part of a weighted sum operation, and the weighted sum operation is used by the loss function.

In some example embodiments, the training of the mock server machine learning model 126 may take place as a dedicated training phase. In other example embodiments, the mock server machine learning model 126 may be retrained dynamically at runtime based on, for example, developer or user feedback.

In some example embodiments, training data may be embedded using an embedding machine learning model 128 prior to being used to train the mock server machine learning model 126. An embedding is a set of coordinates in a latent n-dimensional space such that the proximity (e.g., cosine distance) of the coordinates to other coordinates is indicative of the similarity of the information embedded to those coordinates. Embeddings can be created using machine learning models specifically for the embeddings or specialized layers within other machine learning models. These embedding models/layers therefore rely on extensive training of their own.

The embedding machine learning model 128 may be itself also be trained by any model from among many different potential supervised or unsupervised machine learning algorithms. Examples of supervised learning algorithms include artificial neural networks, Bayesian networks, instance-based learning, support vector machines, linear classifiers, quadratic classifiers, k-nearest neighbor, decision trees, and hidden Markov models.

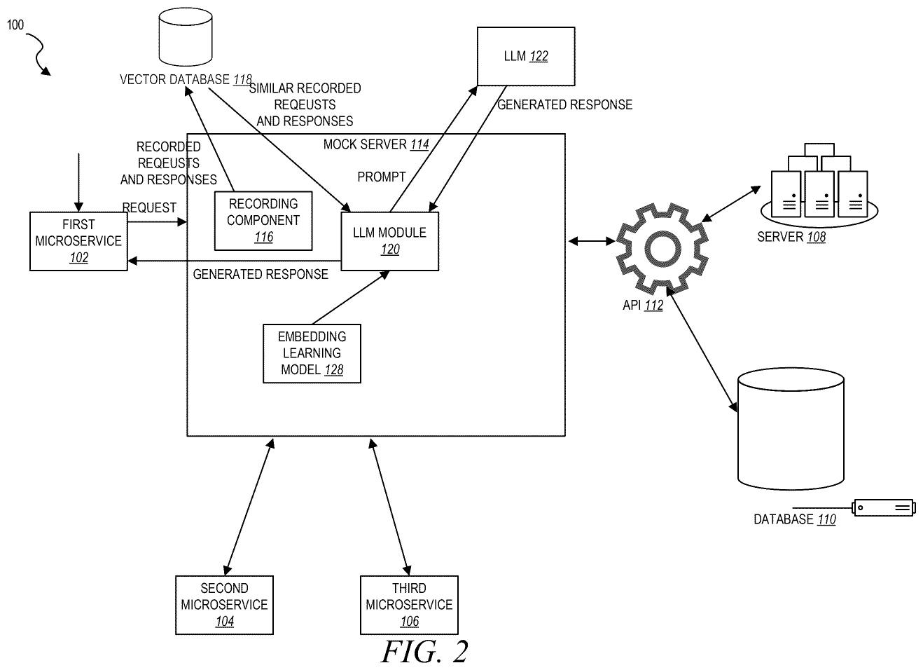

While in FIG. 1 the LLM 122 is used to generate configurations, dependencies, and interactions to be used as training data to train the mock server machine learning model 126 to be used in integration testing, in other example embodiments the LLM 122 may be accessed in real time to generate actual configurations, dependencies, and interactions that are part of the testing itself. FIG. 2 is a block diagram illustrating the system 100 of FIG. 1, where the LLM 122 is directly used in integration testing rather than merely used to generate training data to train a model used in integration testing. Here, no mock server machine learning model training component 124 or mock server machine learning model 126 is needed, but rather the LLM module 120 is used to coordinate mock server responses. Here, while the first microservice 102 is being integration tested, when it sends a request (such as a request including a method, body, and endpoint), this request may be converted to an embedding using the embedding machine learning model 128. It is then compared with prior requests already in the vector database 118. If any are found, then responses made to those prior request may be retrieved from the vector database 118 and returned to the first microservice 102. If no exact matches are found, then similar request information may be retrieved and sent as context with an LLM prompt to the LLM 122, which generates response(s) that can be returned to the first microservice 102.

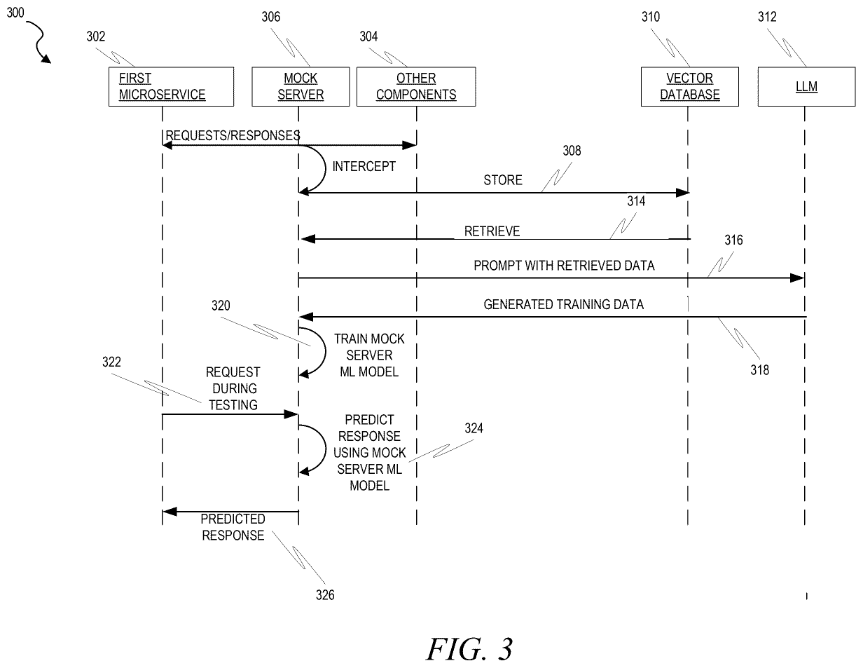

FIG. 3 is a sequence diagram illustrating a method 300 for training a mock server machine learning model to imitate components in a microservices environment for integration testing, in accordance with an example embodiment. Here, actual requests and responses sent between a first microservice 302 and other components 304 are intercepted by a mock server 306 and recorded at operation 308 in vector database 310. Here, for simplicity, other components 304 within the system are represented as a single component but in actuality there may be any number of components, such as other microservices, databases, and servers, that receive and send requests and responses to and from the first microservice. At some point later, at operation 314, the recorded requests and responses are retrieved from the vector database 310 by the mock server 306 and included in a prompt to LLM 312 at operation 316. The LLM 312 generates training data based on the prompt and returns this training data to the mock server 306 at operation 318. At operation 320, the mock server 306 uses the generated training data from the LLM 312 as well as the recorded requests and responses from the vector database 310 to train a mock server machine learning model within the mock server 306. At some point later, at operation 322, during integration testing, the first microservice 302 sends a request to one of the other components 304, but this request can be intercepted by the mock server 306, eliminating the need for the other components 304 to even be actually running. The mock server 306 then uses the trained mock server machine learning model to predict a proper response or responses to the request at operation 324, and it then sends this response or responses to the first microservice 302 at operation 326.

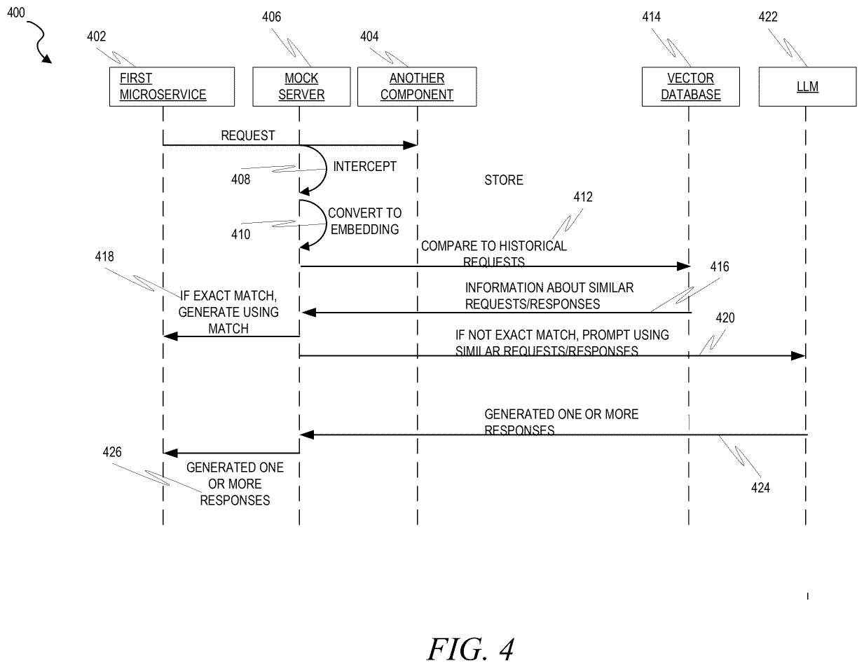

FIG. 4 is a sequence diagram illustrating a method 400 for integration testing a first microservice in a microservices environment, in accordance with an example embodiment. Here, a request from a first microservice 402 to another component 404 in the microservices environment is intercepted by mock server 406 at operation 408. At operation 410, the mock server 406 converts the request to an embedding, such as by using an embedding machine learning model. At operation 412, the mock server 406 compares the embedded request with historical requests stored in vector database 414. Stored information about any identical or similar requests can be returned at operation 416. If there is an identical request in the vector database 414, then the stored information for that identical request (such as the response(s) that was/were issued in response to that request) can be used to generate a response to the first microservice 402 at operation 418. If there are no identical requests but there are similar requests, then at operation 420 the similar requests are sent as part of a prompt to an LLM 422. In response, the LLM 422 generates one or more responses at operation 424. At operation 426, this generated one or more response can then be used to generate a response to the first microservice 402.

It should be noted that the term “similar” as used herein shall be interpreted broadly to define any defined comparison paradigm that attempts to locate requests having features in common or close to in common. There are many possible such defined paradigms. In some example embodiments, the embedding machine learning model itself defines a paradigm that indicates how similar the requests are, based on, for example, vector distance between various features of the underlying requests. Other examples are possible, however, such as ones that utilize syntactical similarity as a measure, and perhaps utilize a defined threshold to indicate a delineation between when requests are similar versus dissimilar (e.g., requests that are 80% or more identical to each other are considered similar).

The mock server machine learning model can also be retrained based on user feedback.

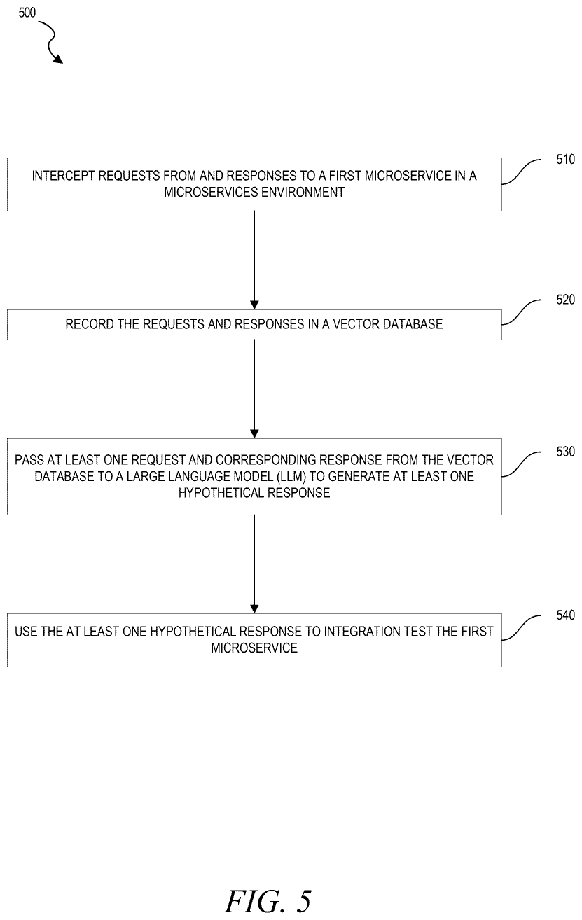

FIG. 5 is a flow diagram illustrating a method 500 in accordance with an example embodiment. At operation 510, requests from and responses to a first microservice in a microservices environment are intercepted. At operation 520, the requests and responses are recorded in a vector database. At operation 530, at least one request and corresponding response are passed from the vector database to a large language model (LLM) to generate at least one hypothetical response. At operation 540, the at least one hypothetical response is used to integration test the first microservice.

In view of the disclosure above, various examples are set forth below. It should be noted that one or more features of an example, taken in isolation or combination, should be considered within the disclosure of this application.

Example 1 is a system comprising: at least one hardware processor; and a computer-readable medium storing instructions that, when executed by the at least one hardware processor, cause the at least one hardware processor to perform operations comprising: intercepting requests from and responses to a first microservice in a microservices environment; recording the requests and responses in a vector database; passing at least one request and corresponding response from the vector database to a large language model (LLM) to generate at least one hypothetical response; and using the at least one hypothetical response to integration test the first microservice.

In Example 2, the subject matter of Example 1 comprises, wherein the using comprises: using the at least one hypothetical response as training data for a mock server machine learning algorithm to train a mock server machine learning model to imitate one or more components other than the first microservice; and during integration testing of the first microservice, receiving a first request from the first microservice to a first component and generating a response to the first request using the mock server machine learning model without the first component being run.

In Example 3, the subject matter of Example 2 comprises, wherein the operations further comprise retraining the mock server machine learning model based on user feedback.

In Example 4, the subject matter of Examples 1-3 comprises, wherein the operations further comprise: receiving a first request from the first microservice to a first component, wherein the passing the at least one request and corresponding response comprises passing a plurality of requests and corresponding responses, for requests that are similar to the first request, to the LLM; and wherein the using further comprises generating a response to the first request using output of the LLM without the first component being run.

In Example 5, the subject matter of Example 4 comprises, wherein the operations further comprise: receiving a second request from the first microservice; locating an identical request to the second request in the vector database; and using a stored response corresponding to the identical request in the vector database to generate a response to the first request using output of the LLM without the first component being run.

In Example 6, the subject matter of Examples 1-5 comprises, wherein the operations further comprise: embedding the requests and responses using an embedding machine learning model, prior to the requests and responses being recorded in the vector database.

In Example 7, the subject matter of Examples 1-6 comprises, wherein the using the at least one hypothetical response to integration test the first microservice is performed in response to a code change of the first microservice.

Example 8 is a method comprising: intercepting requests from and responses to a first microservice in a microservices environment; recording the requests and responses in a vector database; passing at least one request and corresponding response from the vector database to a large language model (LLM) to generate at least one hypothetical response; and using the at least one hypothetical response to integration test the first microservice.

In Example 9, the subject matter of Example 8 comprises, wherein the using comprises: using the at least one hypothetical response as training data for a mock server machine learning algorithm to train a mock server machine learning model to imitate one or more components other than the first microservice; and during integration testing of the first microservice, receiving a first request from the first microservice to a first component and generating a response to the first request using the mock server machine learning model without the first component being run.

In Example 10, the subject matter of Example 9 comprises, retraining the mock server machine learning model based on user feedback.

In Example 11, the subject matter of Examples 8-10 comprises, receiving a first request from the first microservice to a first component, wherein the passing the at least one request and corresponding response comprises passing a plurality of requests and corresponding responses, for requests that are similar to the first request, to the LLM; and wherein the using further comprises generating a response to the first request using output of the LLM without the first component being run.

In Example 12, the subject matter of Example 11 comprises, receiving a second request from the first microservice; locating an identical request to the second request in the vector database; and using a stored response corresponding to the identical request in the vector database to generate a response to the first request using output of the LLM without the first component being run.

In Example 13, the subject matter of Examples 8-12 comprises, embedding the requests and responses using an embedding machine learning model, prior to the requests and responses being recorded in the vector database.

In Example 14, the subject matter of Examples 8-13 comprises, wherein the using the at least one hypothetical response to integration test the first microservice is performed in response to a code change of the first microservice.

Example 15 is a non-transitory machine-readable medium storing instructions which, when executed by one or more processors, cause the one or more processors to perform operations comprising: intercepting requests from and responses to a first microservice in a microservices environment; recording the requests and responses in a vector database; passing at least one request and corresponding response from the vector database to a large language model (LLM) to generate at least one hypothetical response; and using the at least one hypothetical response to integration test the first microservice.

In Example 16, the subject matter of Example 15 comprises, wherein the using comprises: using the at least one hypothetical response as training data for a mock server machine learning algorithm to train a mock server machine learning model to imitate one or more components other than the first microservice; and during integration testing of the first microservice, receiving a first request from the first microservice to a first component and generating a response to the first request using the mock server machine learning model without the first component being run.

In Example 17, the subject matter of Example 16 comprises, wherein the operations further comprise retraining the mock server machine learning model based on user feedback.

In Example 18, the subject matter of Examples 15-17 comprises, wherein the operations further comprise: receiving a first request from the first microservice to a first component, wherein the passing the at least one request and corresponding response comprises passing a plurality of requests and corresponding responses, for requests that are similar to the first request, to the LLM; and wherein the using further comprises generating a response to the first request using output of the LLM, without the first component being run.

In Example 19, the subject matter of Example 18 comprises, wherein the operations further comprise: receiving a second request from the first microservice; locating an identical request to the second request in the vector database; and using a stored response corresponding to the identical request in the vector database to generate a response to the first request using output of the LLM without the first component being run.

In Example 20, the subject matter of Examples 15-19 comprises, wherein the operations further comprise: embedding the requests and responses using an embedding machine learning model, prior to the requests and responses being recorded in the vector database.

Example 21 is at least one machine-readable medium comprising instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

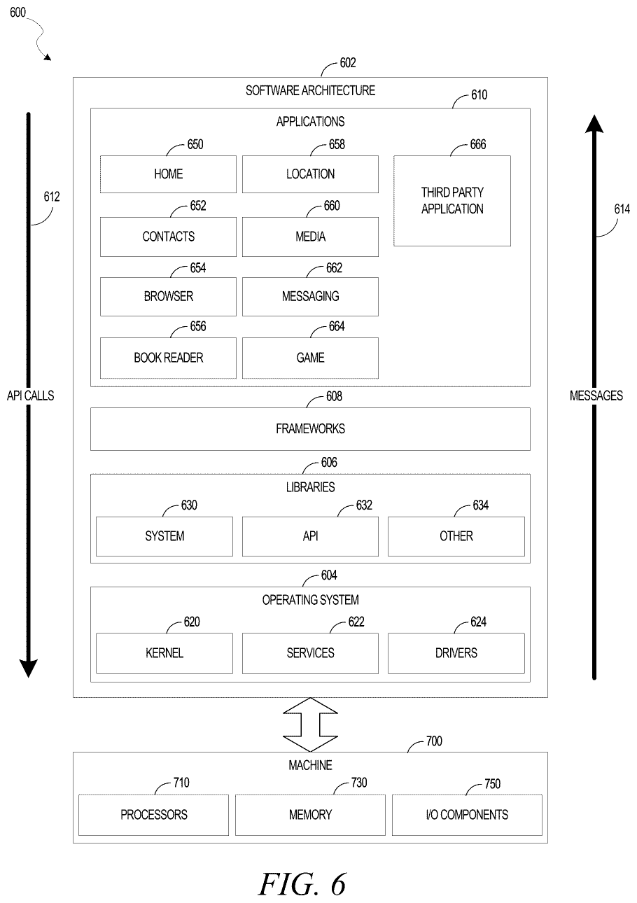

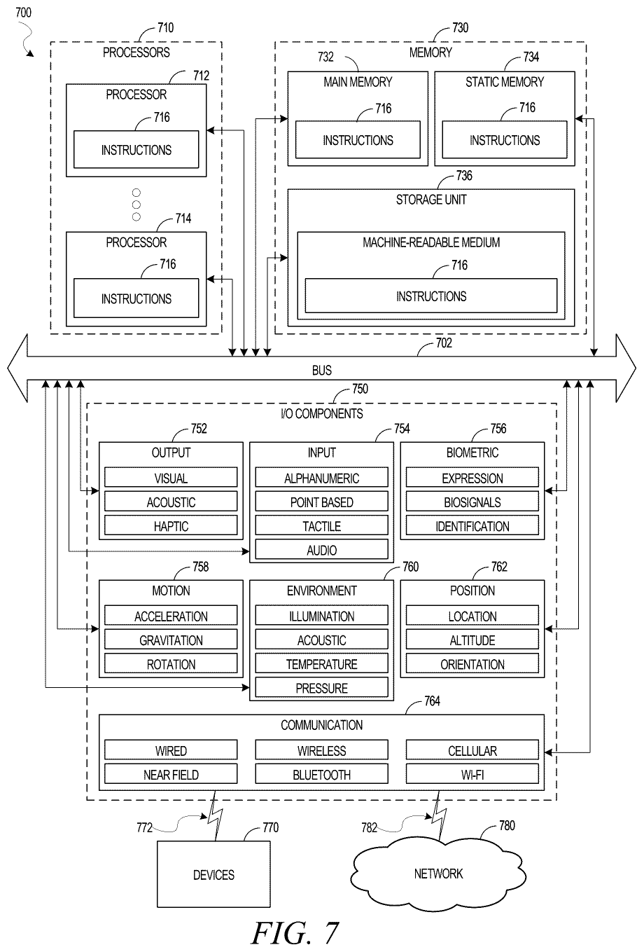

FIG. 6 is a block diagram 600 illustrating a software architecture 602, which can be installed on any one or more of the devices described above. FIG. 6 is merely a non-limiting example of a software architecture, and it will be appreciated that many other architectures can be implemented to facilitate the functionality described herein. In various embodiments, the software architecture 602 is implemented by hardware such as a machine 700 of FIG. 7 that includes processors 710, memory 730, and input/output (I/O) components 750. In this example architecture, the software architecture 602 can be conceptualized as a stack of layers where each layer may provide a particular functionality. For example, the software architecture 602 includes layers such as an operating system 604, libraries 606, frameworks 608, and applications 610. Operationally, the applications 610 invoke API calls 612 through the software stack and receive messages 614 in response to the API calls 612, consistent with some embodiments.

In various implementations, the operating system 604 manages hardware resources and provides common services. The operating system 604 includes, for example, a kernel 620, services 622, and drivers 624. The kernel 620 acts as an abstraction layer between the hardware and the other software layers, consistent with some embodiments. For example, the kernel 620 provides memory management, processor management (e.g., scheduling), component management, networking, and security settings, among other functionalities. The services 622 can provide other common services for the other software layers. The drivers 624 are responsible for controlling or interfacing with the underlying hardware, according to some embodiments. For instance, the drivers 624 can include display drivers, camera drivers, BLUETOOTH® or BLUETOOTH® Low-Energy drivers, flash memory drivers, serial communication drivers (e.g., Universal Serial Bus (USB) drivers), Wi-Fi® drivers, audio drivers, power management drivers, and so forth.

In some embodiments, the libraries 606 provide a low-level common infrastructure utilized by the applications 610. The libraries 606 can include system libraries 630 (e.g., C standard library) that can provide functions such as memory allocation functions, string manipulation functions, mathematic functions, and the like. In addition, the libraries 606 can include API libraries 632 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic context on a display), database libraries (e.g., SQLite to provide various relational database functions), web libraries (e.g., WebKit to provide web browsing functionality), and the like. The libraries 606 can also include a wide variety of other libraries 634 to provide many other APIs to the applications 610.

The frameworks 608 provide a high-level common infrastructure that can be utilized by the applications 610, according to some embodiments. For example, the frameworks 608 provide various graphical user interface functions, high-level resource management, high-level location services, and so forth. The frameworks 608 can provide a broad spectrum of other APIs that can be utilized by the applications 610, some of which may be specific to a particular operating system 604 or platform.

In an example embodiment, the applications 610 include a home application 650, a contacts application 652, a browser application 654, a book reader application 656, a location application 658, a media application 660, a messaging application 662, a game application 664, and a broad assortment of other applications, such as a third-party application 666. According to some embodiments, the applications 610 are programs that execute functions defined in the programs. Various programming languages can be employed to create one or more of the applications 610, structured in a variety of manners, such as object-oriented programming languages (e.g., Objective-C, Java, or C++) or procedural programming languages (e.g., C or assembly language). In a specific example, the third-party application 666 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 666 can invoke the API calls 612 provided by the operating system 604 to facilitate functionality described herein.

FIG. 7 illustrates a diagrammatic representation of a machine 700 in the form of a computer system within which a set of instructions may be executed for causing the machine 700 to perform any one or more of the methodologies discussed herein, according to an example embodiment. Specifically, FIG. 7 shows a diagrammatic representation of the machine 700 in the example form of a computer system, within which instructions 716 (e.g., software, a program, an application, an applet, an app, or other executable code) for causing the machine 700 to perform any one or more of the methodologies discussed herein may be executed. For example, the instructions 716 may cause the machine 700 to execute the method 500 of FIG. 5. Additionally, or alternatively, the instructions 716 may implement FIGS. 1-5 and so forth. The instructions 716 transform the general, non-programmed machine 700 into a particular machine 700 programmed to carry out the described and illustrated functions in the manner described. In alternative embodiments, the machine 700 operates as a standalone device or may be coupled (e.g., networked) to other machines. In a networked deployment, the machine 700 may operate in the capacity of a server machine or a client machine in a server-client network environment, or as a peer machine in a peer-to-peer (or distributed) network environment. The machine 700 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 716, sequentially or otherwise, that specify actions to be taken by the machine 700. Further, while only a single machine 700 is illustrated, the term “machine” shall also be taken to include a collection of machines 700 that individually or jointly execute the instructions 716 to perform any one or more of the methodologies discussed herein.

The machine 700 may include processors 710, memory 730, and I/O components 750, which may be configured to communicate with each other such as via a bus 702. In an example embodiment, the processors 710 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 712 and a processor 714 that may execute the instructions 716. The term “processor” is intended to include multi-core processors that may comprise two or more independent processors (sometimes referred to as “cores”) that may execute instructions 716 contemporaneously. Although FIG. 7 shows multiple processors 710, the machine 700 may include a single processor 712 with a single core, a single processor 712 with multiple cores (e.g., a multi-core processor 712), multiple processors 712, 714 with a single core, multiple processors 712, 714 with multiple cores, or any combination thereof.

The memory 730 may include a main memory 732, a static memory 734, and a storage unit 736, each accessible to the processors 710 such as via the bus 702. The main memory 732, the static memory 734, and the storage unit 736 store the instructions 716 embodying any one or more of the methodologies or functions described herein. The instructions 716 may also reside, completely or partially, within the main memory 732, within the static memory 734, within the storage unit 736, within at least one of the processors 710 (e.g., within the processor's cache memory), or any suitable combination thereof, during execution thereof by the machine 700.

The I/O components 750 may include a wide variety of components to receive input, provide output, produce output, transmit information, exchange information, capture measurements, and so on. The specific I/O components 750 that are included in a particular machine will depend on the type of machine. For example, portable machines such as mobile phones will likely include a touch input device or other such input mechanisms, while a headless server machine will likely not include such a touch input device. It will be appreciated that the I/O components 750 may include many other components that are not shown in FIG. 7. The I/O components 750 are grouped according to functionality merely for simplifying the following discussion, and the grouping is in no way limiting. In various example embodiments, the I/O components 750 may include output components 752 and input components 754. The output components 752 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 754 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 750 may include biometric components 756, motion components 758, environmental components 760, or position components 762, among a wide array of other components. For example, the biometric components 756 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 758 may include acceleration sensor components (e.g., accelerometer), gravitation sensor components, rotation sensor components (e.g., gyroscope), and so forth. The environmental components 760 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 762 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 750 may include communication components 764 operable to couple the machine 700 to a network 780 or devices 770 via a coupling 782 and a coupling 772, respectively. For example, the communication components 764 may include a network interface component or another suitable device to interface with the network 780. In further examples, the communication components 764 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 770 may be another machine or any of a wide variety of peripheral devices (e.g., coupled via a USB).

Moreover, the communication components 764 may detect identifiers or include components operable to detect identifiers. For example, the communication components 764 may include radio-frequency identification (RFID) tag reader components, NFC smart tag detection components, optical reader components (e.g., an optical sensor to detect one-dimensional bar codes such as Universal Product Code (UPC) bar code, multi-dimensional bar codes such as QR code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 764, such as location via Internet Protocol (IP) geolocation, location via Wi-Fi® signal triangulation, location via detecting an NFC beacon signal that may indicate a particular location, and so forth.

The various memories (e.g., 730, 732, 734, and/or memory of the processor(s) 710) and/or the storage unit 736 may store one or more sets of instructions 716 and data structures (e.g., software) embodying or utilized by any one or more of the methodologies or functions described herein. These instructions (e.g., the instructions 716), when executed by the processor(s) 710, cause various operations to implement the disclosed embodiments.

As used herein, the terms “machine-storage medium,” “device-storage medium,” and “computer-storage medium” mean the same thing and may be used interchangeably. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate array (FPGA), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 780 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 780 or a portion of the network 780 may include a wireless or cellular network, and the coupling 782 may be a Code Division Multiple Access (CDMA) connection, a Global System for Mobile communications (GSM) connection, or another type of cellular or wireless coupling. In this example, the coupling 782 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

The instructions 716 may be transmitted or received over the network 780 using a transmission medium via a network interface device (e.g., a network interface component included in the communication components 764) and utilizing any one of a number of well-known transfer protocols (e.g., HTTP). Similarly, the instructions 716 may be transmitted or received using a transmission medium via the coupling 772 (e.g., a peer-to-peer coupling) to the devices 770. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 716 for execution by the machine 700, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

What is claimed is:

1. A system comprising:
at least one hardware processor; and
a computer-readable medium storing instructions that, when executed by the at least one hardware processor, cause the at least one hardware processor to perform operations comprising:
intercepting requests from and responses to a first microservice in a microservices environment;
recording the requests and responses in a vector database;
passing at least one request and corresponding response from the vector database to a large language model (LLM) to generate at least one hypothetical response; and
using the at least one hypothetical response to integration test the first microservice.

2. The system of claim 1, wherein the using comprises:
using the at least one hypothetical response as training data for a mock server machine learning algorithm to train a mock server machine learning model to imitate one or more components other than the first microservice; and
during integration testing of the first microservice, receiving a first request from the first microservice to a first component and generating a response to the first request using the mock server machine learning model without the first component being run.

3. The system of claim 2, wherein the operations further comprise retraining the mock server machine learning model based on user feedback.

4. The system of claim 1, wherein the operations further comprise:
receiving a first request from the first microservice to a first component, wherein the passing the at least one request and corresponding response includes passing a plurality of requests and corresponding responses, for requests that are similar to the first request, to the LLM; and
wherein the using further comprises generating a response to the first request using output of the LLM, without the first component being run.

5. The system of claim 4, wherein the operations further comprise:
receiving a second request from the first microservice;
locating an identical request to the second request in the vector database; and
using a stored response corresponding to the identical request in the vector database to generate a response to the first request using output of the LLM, without the first component being run.

6. The system of claim 1, wherein the operations further comprise:
embedding the requests and responses using an embedding machine learning model, prior to the requests and responses being recorded in the vector database.

7. The system of claim 1, wherein the using the at least one hypothetical response to integration test the first microservice is performed in response to a code change of the first microservice.

8. A method comprising:
intercepting requests from and responses to a first microservice in a microservices environment;
recording the requests and responses in a vector database;
passing at least one request and corresponding response from the vector database to a large language model (LLM) to generate at least one hypothetical response; and
using the at least one hypothetical response to integration test the first microservice.

9. The method of claim 8, wherein the using comprises:
using the at least one hypothetical response as training data for a mock server machine learning algorithm to train a mock server machine learning model to imitate one or more components other than the first microservice; and
during integration testing of the first microservice, receiving a first request from the first microservice to a first component and generating a response to the first request using the mock server machine learning model without the first component being run.

10. The method of claim 9, further comprising retraining the mock server machine learning model based on user feedback.

11. The method of claim 8, further comprising:
receiving a first request from the first microservice to a first component, wherein the passing the at least one request and corresponding response includes passing a plurality of requests and corresponding responses, for requests that are similar to the first request, to the LLM; and
wherein the using further comprises generating a response to the first request using output of the LLM, without the first component being run.

12. The method of claim 11, further comprising:
receiving a second request from the first microservice;
locating an identical request to the second request in the vector database; and
using a stored response corresponding to the identical request in the vector database to generate a response to the first request using output of the LLM without the first component being run.

13. The method of claim 8, further comprising:
embedding the requests and responses using an embedding machine learning model, prior to the requests and responses being recorded in the vector database.

14. The method of claim 8, wherein the using the at least one hypothetical response to integration test the first microservice is performed in response to a code change of the first microservice.

15. A non-transitory machine-readable medium storing instructions which, when executed by one or more processors, cause the one or more processors to perform operations comprising:
intercepting requests from and responses to a first microservice in a microservices environment;
recording the requests and responses in a vector database;
passing at least one request and corresponding response from the vector database to a large language model (LLM) to generate at least one hypothetical response; and
using the at least one hypothetical response to integration test the first microservice.

16. The non-transitory machine-readable medium of claim 15, wherein the using comprises:
using the at least one hypothetical response as training data for a mock server machine learning algorithm to train a mock server machine learning model to imitate one or more components other than the first microservice; and
during integration testing of the first microservice, receiving a first request from the first microservice to a first component and generating a response to the first request using the mock server machine learning model without the first component being run.

17. The non-transitory machine-readable medium of claim 16, wherein the operations further comprise retraining the mock server machine learning model based on user feedback.

18. The non-transitory machine-readable medium of claim 15, wherein the operations further comprise:
receiving a first request from the first microservice to a first component, wherein the passing the at least one request and corresponding response includes passing a plurality of requests and corresponding responses, for requests that are similar to the first request, to the LLM; and
wherein the using further comprises generating a response to the first request using output of the LLM, without the first component being run.

19. The non-transitory machine-readable medium of claim 18, wherein the operations further comprise:
receiving a second request from the first microservice;
locating an identical request to the second request in the vector database; and
using a stored response corresponding to the identical request in the vector database to generate a response to the first request using output of the LLM without the first component being run.

20. The non-transitory machine-readable medium of claim 15, wherein the operations further comprise:
embedding the requests and responses using an embedding machine learning model, prior to the requests and responses being recorded in the vector database.
